(19) United States
(12) Patent Application Publication
(10) Pub. No.: US 2021/0334761 A1
(43) Pub. Date: Oct. 28, 2021

(54) Video-Bot based System and Method for Continually improving the Quality of Candidate Screening Process, Candidate Hiring Process and Internal Organizational Promotion Process, using Artificial Intelligence, Machine Learning Technology and Statistical Inference based Automated Evaluation of responses that employs a scalable Cloud Architecture

(71) Applicant: Milind Kishor Thombre, Pune (IN)

(72) Inventor: Milind Kishor Thombre, Pune (IN)

(21) Appl. No.: 17/239,941

(22) Filed: Apr. 26, 2021

Related U.S. Application Data
(60) Provisional application No. 63/016,736, filed on Apr. 28, 2020.

(51) Int. Cl. G06Q 10/10; G10L 15/26; G10L 13/02; H04N 5/76

(52) U.S. Cl. CPC G06Q 10/1053; H04N 5/76; G10L 13/02; G10L 15/26

(57) ABSTRACT

Our innovation is a System and Method deployable as a SaaS(Software as a Service) that aims to serve multiple Global Clients concurrently. This innovation deploys a Video-Bot as the Human-Computer Interface wherein the candidate gets to choose his/her favorite personality as the interviewer. This innovation screens candidates in the following sequence: Automated administration of the Technical skills test; Automated Administration of Technical Interview using Video-bot technology; Automated administration of HR-interview with Video-Bot technology; Automated Machine Learning, AI and NLP based offline evaluation and generation of a comprehensive report for the above 3 steps followed by: The Human Interview whose sole purpose is to detect red flags (FIG. 1). Concurrency reduces the possibility of fraud and collusion between different candidates. This innovation screens talent for hiring new talent externally as well as internal job promotions and annual evaluations.

This invention is a follow on from the Provisional Utility application filed on 28 Apr. 2020 bearing application No. 63/016,736

### BACKGROUND OF THE INVENTION

Screening a large pool of candidates and choosing the best fit for the job from a shortlist remains a daunting and laborious process. We note that successful organisations are composed of the right people in the right spots in the organisation-tree.

Recruiting remains the Achilles heel of all growing Organisations or of Organisations that face attrition, or both, and as such this is a key Organisation-Building activity. Note that the screening activity is often de-prioritised in organisations for certain human reasons.

Human factors/reasons may include time constraints of the technical person or specialist or subject matter expert. Usually (last minute) hiring occurs when the project is in the critical phase and that is exactly when the technical specialist is most overworked and/or stressed due to project priorities. This may mean he/she de-priorities hiring tasks OR makes a quick hasty decision at a stressful time, which is likely to be wrong!

There may also be a perception of competition from the candidate by the existing employees, who are often tasked with the screening process. This introduces excessive human opinions and there is a reasonably high likelihood of a wrong decision being made due to possible vested interests of the interviewer.

Other constraints such as inefficient and non-deterministic processes such as resume-screening are usually ineffective as candidates who write good resumes, may actually not always be the best fit for the job at hand, unless the job involves creative writing.

Issues exist with the quality and associated costs, both direct and indirect, of such interviews and ad-hoc screening processes, caused by human nature and the inherent variability in the skill and experience of the interviewer himself/herself.

To name a few issues, several times such interviews are not standardised, of poor quality and the content is variable and not addressed fully, presence of bias of the interviewer, non-scalability of the process due to bottlenecks caused by lack of skilled human interviewer availability.

Note that the recruiting organisations may be exposed to liability due this defective, potentially unjust and human oriented subjective process.

We note that Machine learning and Artificial Intelligence once applied successfully will constantly improve the process of the interview as more training data becomes available and feedback loops of current performance and outcomes versus past interview performance are closed by the current invention.

Cloud Technology has now enabled us to create and maintain a single near-fully automated system that can be controlled centrally. Also, horizontal scaling properties of current Cloud service providers enables us to deploy heavy “Online Technical Tests” or “Interview bot” workloads concurrently.

This nearly eliminates the possibility of “question leaks” between various candidate batches worldwide

The last leg of any selection process is the Human Resources (HR) interview. An increasingly large number of these generic interviews take place across industry, government and academia and basically between any candidate and potential employer.

Note that tests and interviews are also mandated when someone is put up for promotion to gauge suitability for the position the candidate would assume.

NLP (Natural Language Processing), Video and Bot technology (we call this combination Video-bot) are employed to vastly improve the Human Computer Interface thus giving the candidate a more human-like testing and interview experience.

Better Record Keeping and Automation reduces the risk of losses caused to the business due to potential liability.

Fully automated non-real time Machine learning Technology is employed to evaluate and create the output report from the following:
1. Candidate responses to tests and interviews
2. Candidate resume and
3. Historical data of candidates

### BRIEF SUMMARY OF THE INVENTION

Our innovation is a System and Method deployable as a SaaS(Software as a Service) that aims to serve multiple Global Clients concurrently. This innovation deploys a Video-Bot as the Human-Computer Interface wherein the candidate gets to choose his/her favourite personality as the interviewer. This innovation screens candidates in the following sequence: Automated administration of skills test; Automated Administration of Technical Interview using Video-bot technology; Automated administration of HR-interview with Video-Bot technology; Automated Machine Learning, AI and NLP based offline evaluation and generation of a comprehensive report for the above 3 steps followed by: The Human Interview whose sole purpose is to detect red flags. (FIG. 1). Concurrency reduces the possibility of fraud and collusion between candidates. This innovation screens talent for hiring new talent externally as well as internal job promotions and annual evaluations.

This innovation has 2 main pluggable parts:
1. Automated Testing, this is usually a near-real time module
2. Automated Evaluation, this is typically an offline batch processing module

Automated testing has in turn has 2 parts:
1. Pluggable customisable test modules which comprise Question-Answer sets per skill module or domain area.
2. Interview Module for open ended questions

Automated Evaluation uses the following techniques:
1. Lookup technique to evaluate multiple-choice questions
2. Lookup or range checking technique for evaluating questions with a numerical answer.
3. Machine learning and Artificial Intelligence and Natural Language Processing techniques for evaluating questions with descriptive answers

### BRIEF DESCRIPTION OF DRAWINGS

FIG. 1 depicts the overall workflow of the Candidate Screening and Selection system

FIG. 2 depicts in a graphical fashion the advantages of our innovation

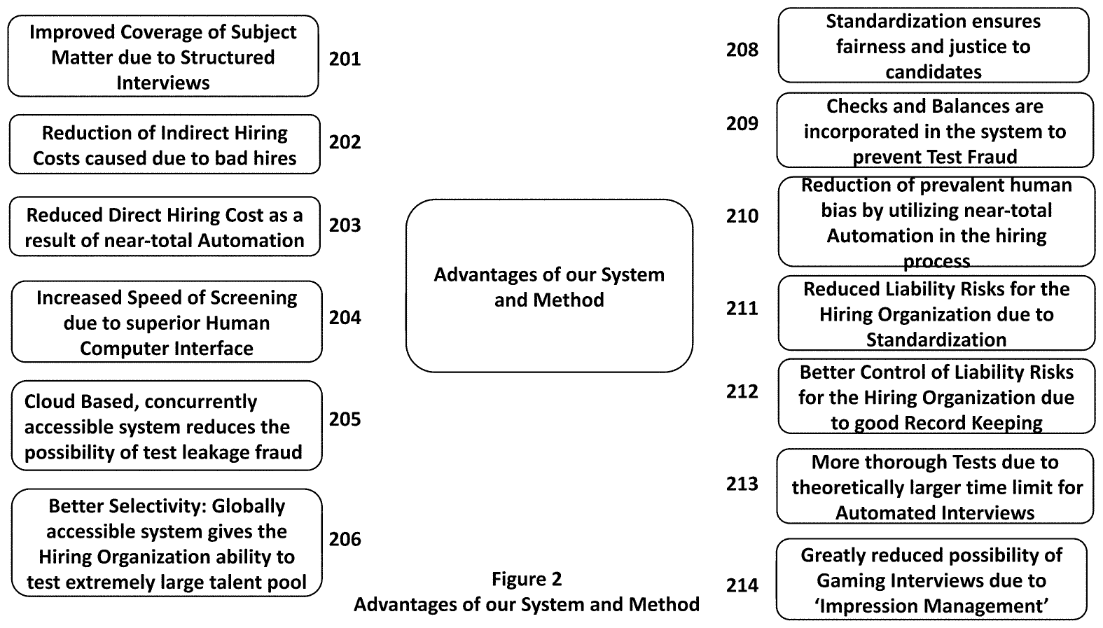

FIG. 3 depicts the various factors that affect human judgement including bias, mood of interviewer and impression creation due to temporal placement of questions during an interview

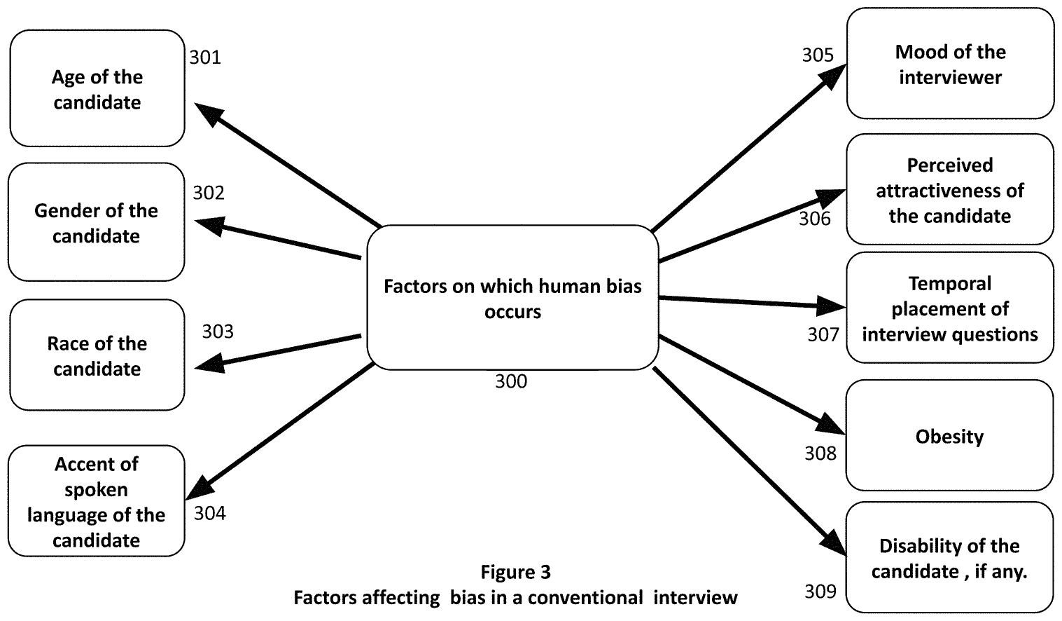

FIG. 4 depicts the Cloud based Architecture of our innovation which serves multiple global clients concurrently.

FIG. 5 depicts an instance of the innovation deployed for each global client

FIG. 6 depicts the customisability and flexibility of the innovation for a particular level of experience for a particular job description.

FIG. 7 depicts the typical contents in a sample candidate evaluation report

FIG. 8 depicts the fulfilment of various internal and external compliance requirements met by the innovation

FIG. 9 computes the direct cost savings for a sample organisation that utilises the innovation

FIG. 10 details the speech, text and video Human-Computer Interfaces designed into the innovation

FIG. 11 illustrates the possibility of accessing the innovation via various computing devices

FIG. 12 demonstrates the detailed interactive interview sub-system flow

### DETAILED DESCRIPTION OF INVENTION

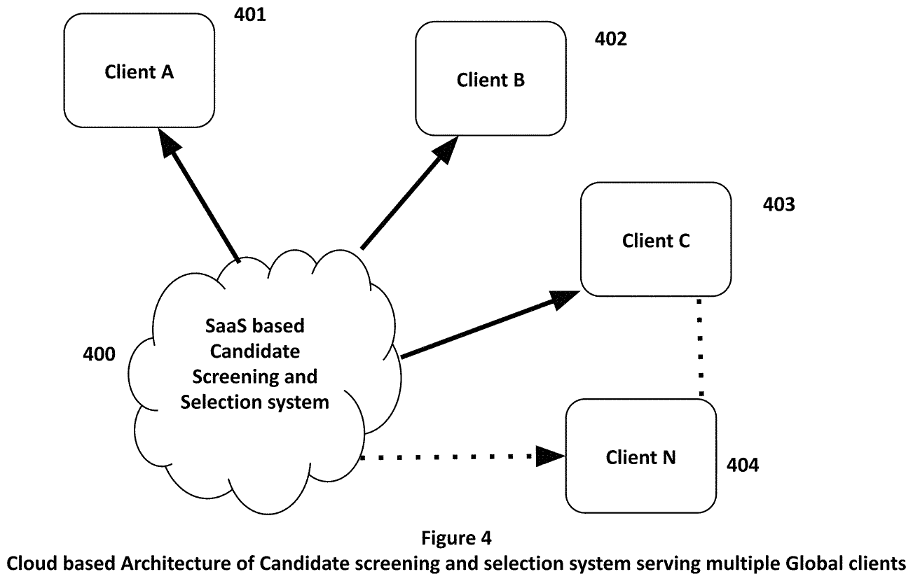

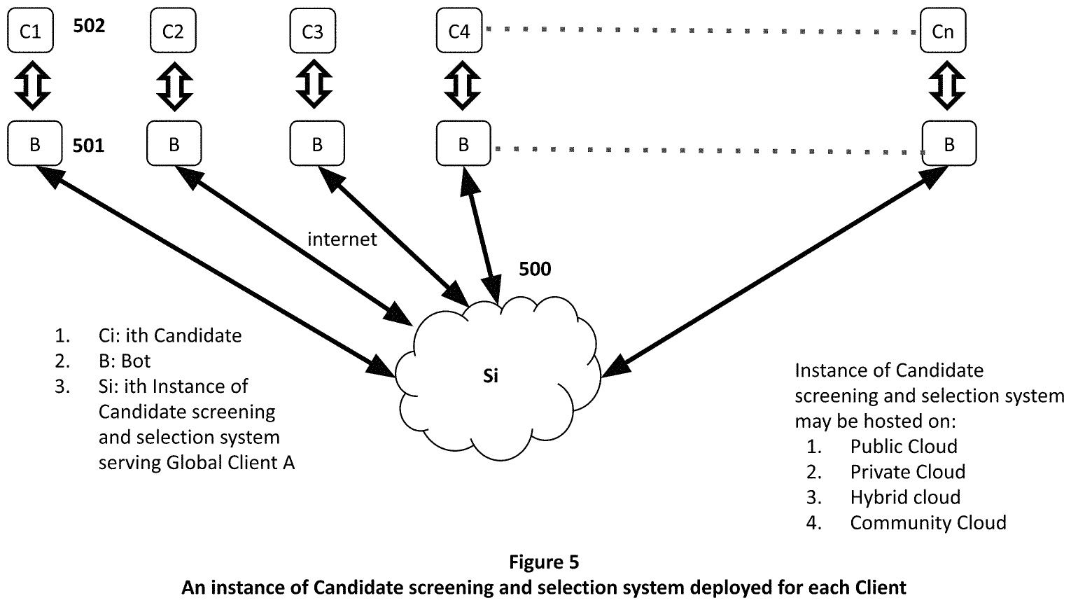

This innovation serves multiple global clients concurrently. Horizontal scalability of cloud architecture allows our innovation to achieve this as shown in FIG. 4. We note that each global client may access this system from various geographically distributed locations. As shown in FIG. 5 each global client may conduct several types of skill tests and interviews concurrently.

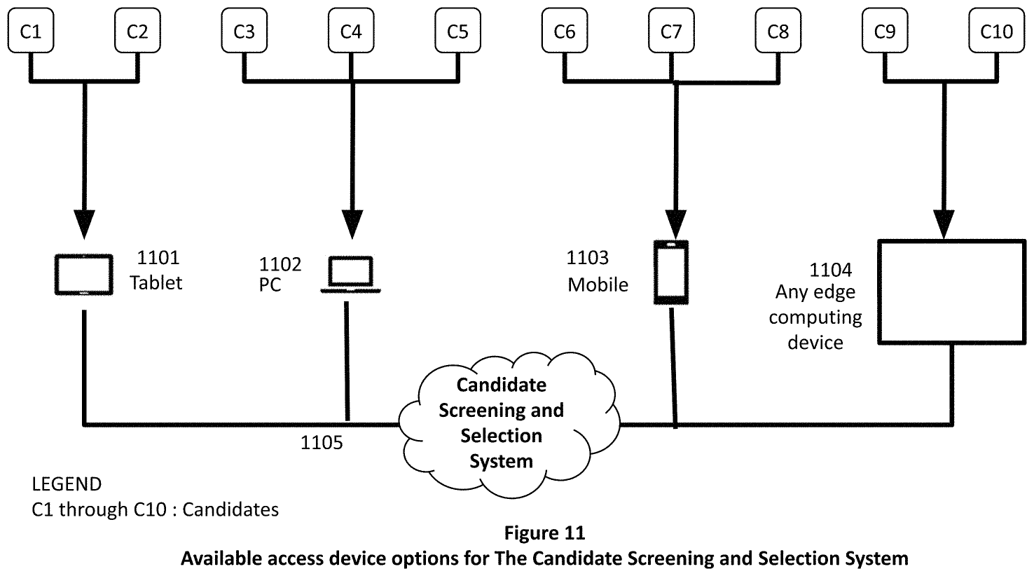

We also note that various candidates may be attempting each particular test type or interview concurrently. We also note that each candidate as shown in —FIG. 11 may access the test via one of the several types of edge computing devices. The edge device must necessarily have audio and video input and output as well as limited computing capabilities, as are available in devices nowadays.

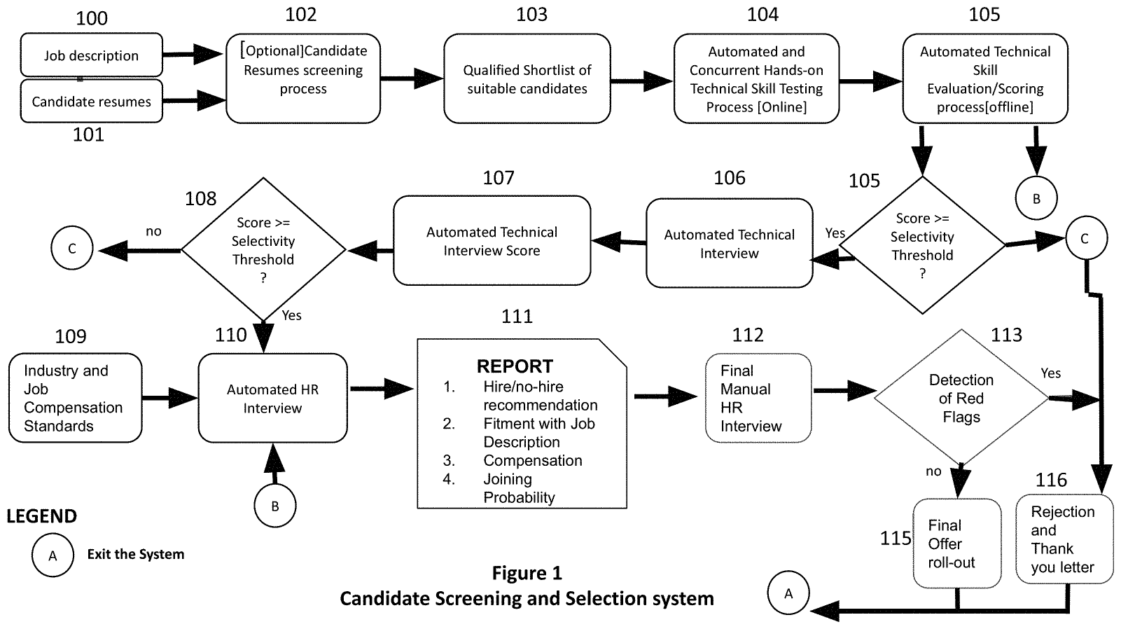

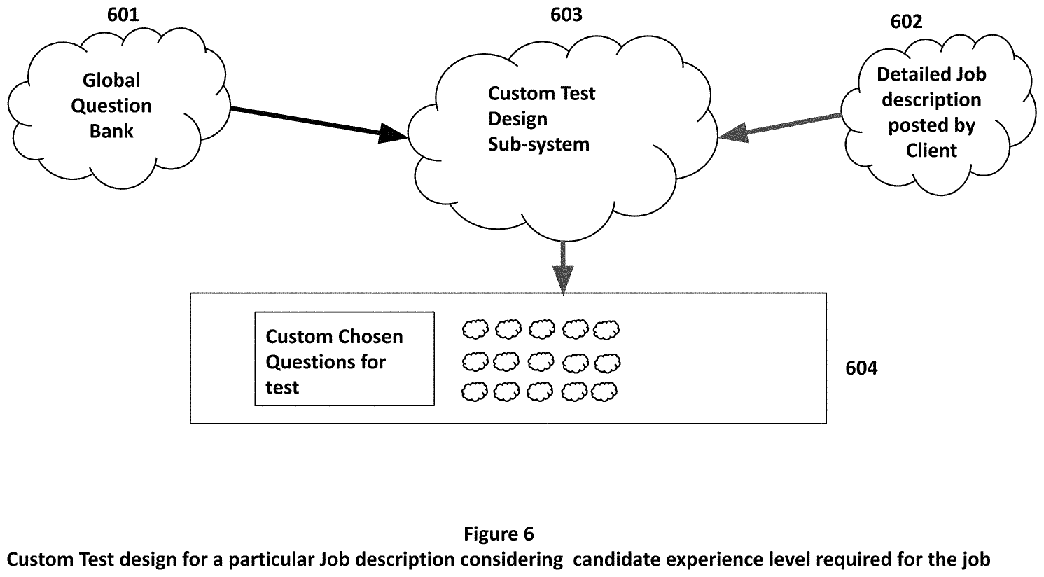

Each candidate evaluation will have the following workflow as shown in FIG. 1. The method for the candidate evaluation disclosed herein firstly considers the job description FIG. 1 [100] and the resume FIG. 1 [101] submitted by the candidate at the time of application. The resumes FIG. 1 [101] of all candidates are then screened to shortlist suitable candidates. Once all resumes FIG. 1 [101] are screened, a shortlist of candidates is made and the shortlisted candidates are then called for further tests and interviews. Thereafter the detailed job description posted by the Organisation is analysed to extract the experience level of the desired candidate as shown in FIG. 6 [602]. The information thus extracted is passed on to the custom test design sub-system FIG. 6 [603]. The test design sub-system FIG. 6 [603] then picks the appropriate questions from the global question bank FIG. 6 [601] to come up with the optimal Test design FIG. 6[604]. The questions are thus selected to match the experience level and skill level of the candidate thus providing an equal standard of questions to all candidates at the same experience band and skill level.

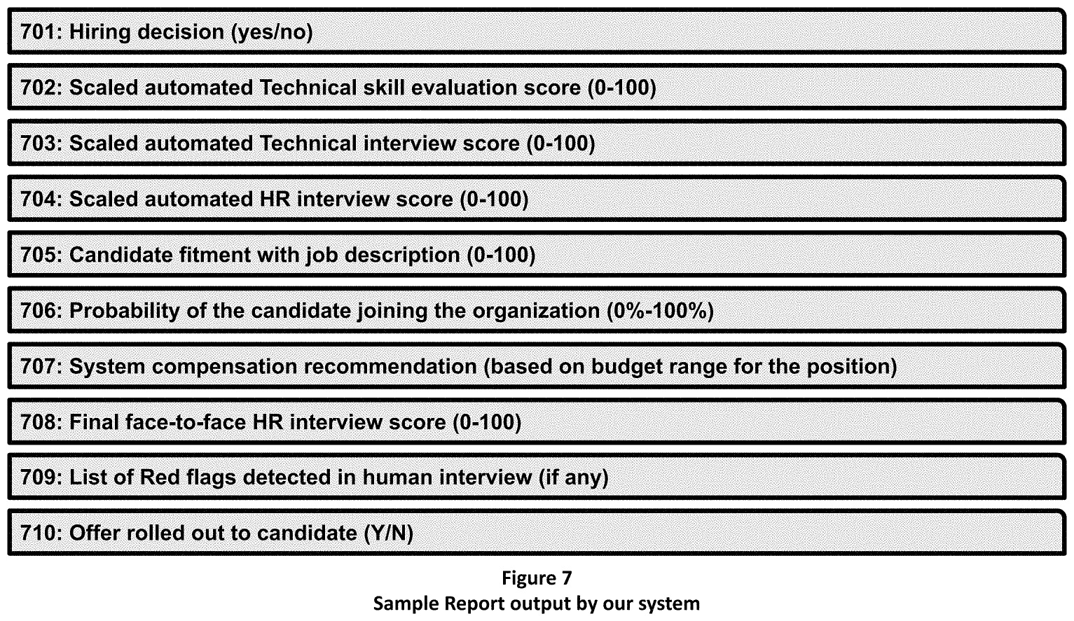

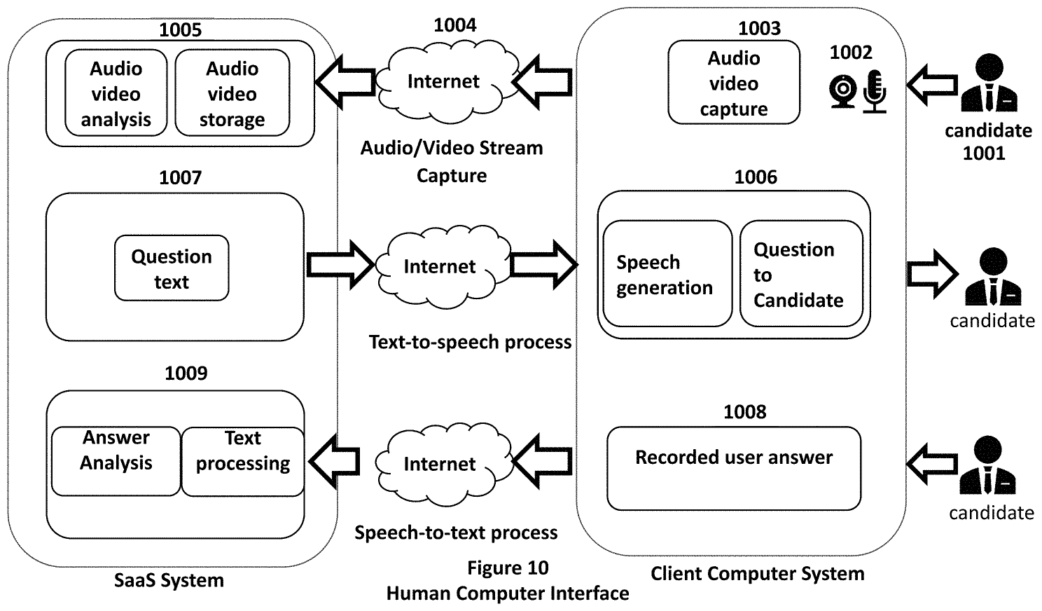

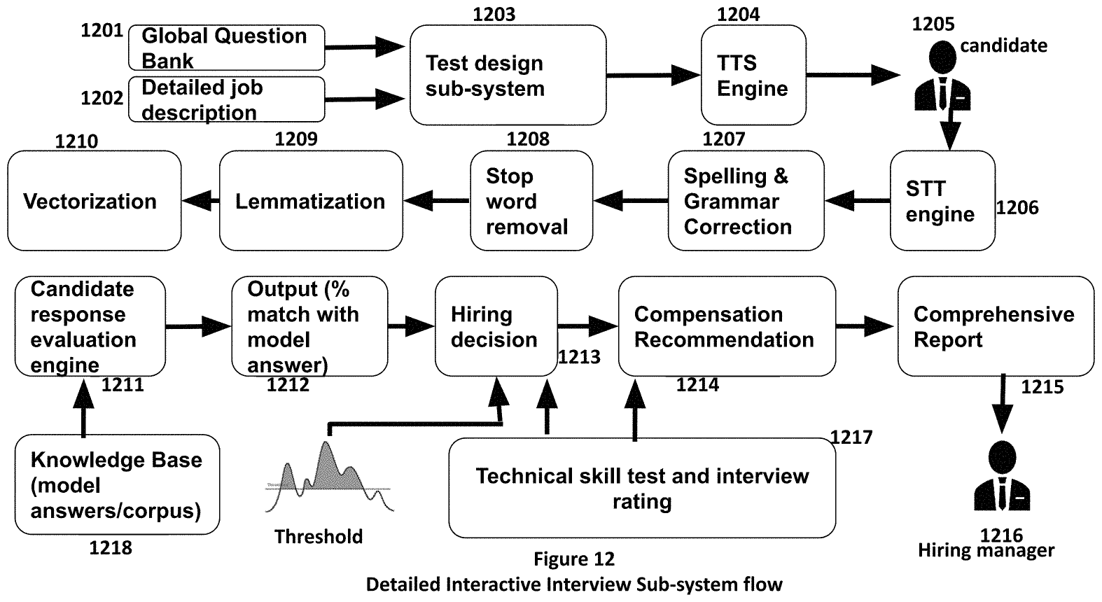

The process of interview comprises of five parts—
1. The qualified candidates are first asked to appear for the Automated and Concurrent Hands-on Online Technical Skill Testing Process FIG. 1 [104]. This is the first screening test that the candidates have to appear for participating in the further interview process. The responses given by the candidates are further evaluated by the Automated Technical Skill Evaluation/Scoring process FIG. 1 [105] and all the candidates having scores above the predetermined threshold score qualify for the next process
2. Automated Technical interview process. The process as shown in FIG. 1 [106] conducts the technical interview of the candidate(s) using the innovative Video-bot technology which enhances the Human Computer Interface for the User. The video bot asks the custom chosen question to the candidate by using the text-to-speech technology wherein the question text FIG. 10 [1007] is converted to speech and then the question is asked to the candidate FIG. 10 [1006]. The candidate responses are recorded FIG. 10 [1008] and converted into text by the speech-to-text technology as discussed in FIG. 10. The recorded answer FIG. 10 [1008] is further sent for analysis and text processing FIG. 10 [1009] via hi-speed internet FIG.
3. [1004]. The recorded answer FIG. 10 [1008] is then matched with the model answer set and the answer is graded on the basis of percentage match with the model answer set using state of the art Machine Learning, NLP, Artificial Intelligence and Statistical Inference. Further, all candidates having a score greater than the predetermined threshold score in the technical interview qualify for the next Automated Human Resource (HR) Interview process FIG. 1 [110].
4. The video bot conducts the HR interviews as well FIG. 1 [110]. But before the HR interview it takes the following things into account Industry and Job Compensation Standards FIG. 1 [109], Past scores of the candidate including:
   A. Technical skill evaluation test s core FIG. 1 [105] and
   B. Technical interview score FIG. 1 [110] as input since it is also assigned with the job of making and then presenting a comprehensive report FIG. 12 [1215] to the HR manager FIG. 12 [1216] who has to take the final decisions. A report is created as shown in FIG. 7 and FIG. 1[111]
5. Thereafter the candidates who secure a good rating after the Automated HR interview FIG. 1 [110] qualify to appear for the final manual face-to-face HR interview FIG. 1 where the main aim is to check the presence of “Red Flags” FIG. 1 [113]. If no red [112] flags FIG. 1 [113] are detected after the final HR manual interview FIG. 1 [112] the candidate is handed with a final offer roll-out FIG. 1 [115]. In all other cases where the candidate does not qualify, he/she is sent a polite rejection note and a “Thank You for applying” note FIG. 1 [116].

The workflow described in FIG. 1 will create an output report in FIG. 7 for each qualifying candidate. The format of the sample report generated by the innovation is as follows:
1. System Hire/No-Hire Decision
2. Technical skill evaluation score FIG. 7 [702]
3. Technical Interview score FIG. 7 [703],
4. HR interview score FIG. 7 [704]
5. Fitment of the candidate FIG. 7 [705] with the job description scaled between 0-100
6. probability of the candidate joining the organisation FIG. 7 [706]
7. Recommended compensation offered by the organisation based on the minimum and maximum budget range for the position FIG. 7 [707]
8. Manual HR interview score FIG. 7 [708] all scaled from 0-100.
9. The innovation provides the Hiring Authority the ability to enter a list of Red Flags if any are detected during the human interaction FIGS. 7 [709] and
10. The innovation gives the hiring authority the status of the rollout of the offer FIG. 7 [710].

The overview of the NLP sub-system is shown in FIG. 12.

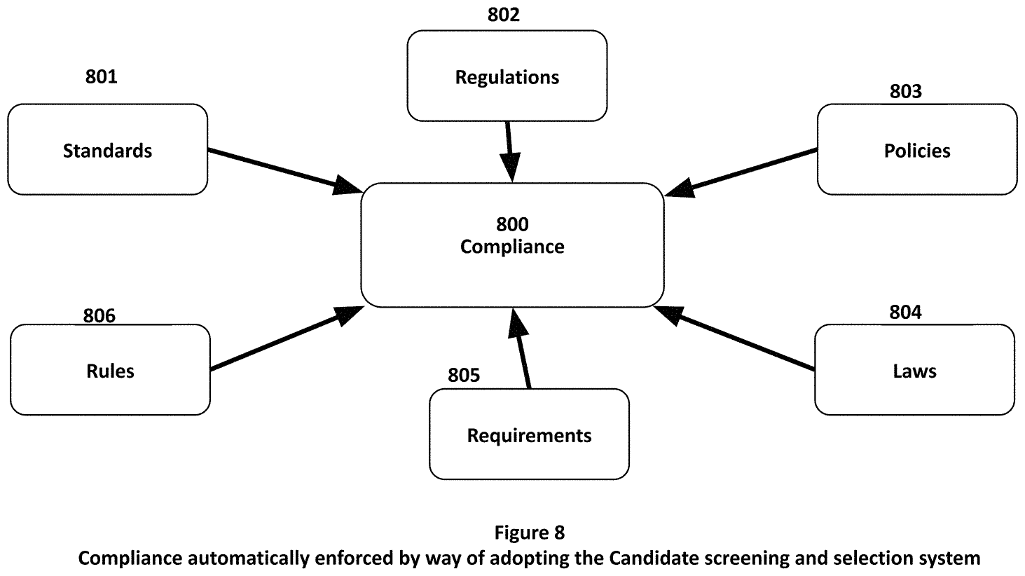

FIG. 8 [800] Compliance with local and national laws FIG. 8 [804], FIG. 8 [806], FIG. 8 [802] rules and regulations is automatically programmed into the innovation. These are updated from time to time to keep up with Laws of the Lands. Additionally FIG. 8 [803] Corporate Policy (e.g. policy on compensation) and FIG. 8 [801] minimum hiring standards are defined by each Organisation and are subsequently applied by the innovation for all hires made by that Organisation. Last but not the least, the system ensures that the candidates meet the minimum Requirements defined for the position FIG. 8 [805].

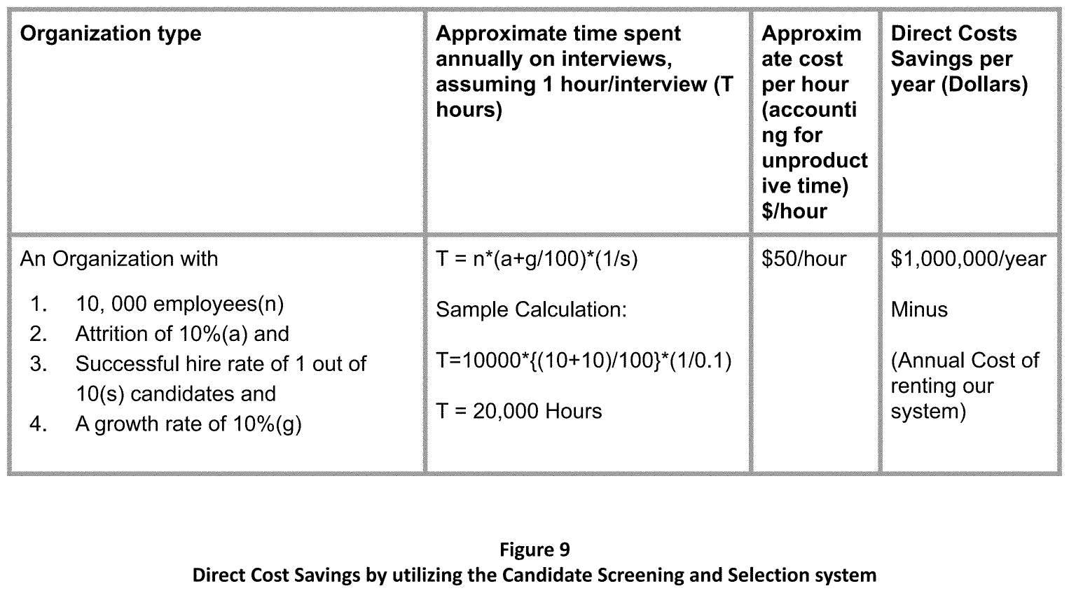

FIG. 9 illustrates cost savings for a mid-sized sample organisation.

This would also lead to an indirect cost saving for the organisation as adoption and use of the innovation would also result in placing the right candidate at the right position in the Organisation reducing the indirect costs incurred by the organisation due to wrong hires.

1. I claim that this system will provide an enhanced candidate interview experience due to integration of a seamless Human Computer Interface by using Video-bot technology for Interviews. The computer Screen will display a humanoid video-bot or a personality speaking in real time to the candidate by utilising Text-to-Speech and video technology to convert textual questions in the Question set to video. The candidates' in-camera responses will be recorded and transcribed to text using Automated Speech Recognition (ASR) system. We call this innovation the Video User Interface. This is a big improvement over other slower character based or voice based bots. Typically the average speed of typing is 40 words per minute. Using our technology, the speed of recording approaches the speed of natural human expression which is typically 150-200 words/minute for the English Language.

2. The system embodied in claim 1, will be a SaaS (Software as a Service) system and will greatly reduce the occurrence of fraud and gaming by ensuring interviews for a particular class of positions for a specific Client Organisation are conducted in parallel at the same time worldwide (concurrently). This will ensure that question and answer sets from one ‘batch’ of candidates are not leaked to another batch who takes the test at a later time. This will be implemented by way of a configurable and partially customisable SaaS Solution which may be hosted either on:
A. Public Cloud
B. Private Cloud or
C. Hybrid Cloud
D. Community Cloud
based on the specific needs of the Client Organisation.

3. The system embodied in claim 1 will greatly enhance the ability of screening and interviewing a much larger and diverse geographically distributed Global Talent Pool, thus, greatly enhancing the selectivity of candidates for the Organisation that adopts this innovation. From the candidates perspective, the system will also serve to create an environment of greater Justice in the fragmented Global Labor Markets and eliminate issues caused by Geographical Boundaries and other protectionist policies worldwide.

4. The system described in claim 1 above will be utilising various cloud based micro-services. The System will remain a multi-device access enabled cloud (SaaS/PaaS) system which will be accessible via a web browser and alternatively via a proprietary application. The only apparatus the candidate needs is:
A. A computing device (this may be a Personal Computer, Mobile Phone OR tablet or any other edge computing device capable of accessing the cloud service
B. A high speed internet connection capable of accessing the Cloud.
C. Camera and Microphone connected to the computing device for video capture.

5. The system described in claim 1 above will further reduce the occurrence of interview fraud by incorporating ‘checks and balances’ implemented via fully automated statistical analysis, Machine Learning and Artificial Intelligence and Drift Analysis in the choice of questions used for test design. For example, in a test, if a difficult answer, which was historically answered correctly by a very small population, but is all of a sudden, getting answered correctly by a large population in the current batch, the system should conclude that the particular question may have been leaked from the system and as such should not be counted towards the scores of that candidate batch. Also, a variant of the question will be created by the system to cover that interview subject area or the question should be eliminated or replaced.

6. I claim that Implementation and full use of the system will result in reduction in individual human biases of the interviewer for or against a particular candidate or class of candidates, such as race, gender, age, physical disability, obesity, accent, perceived attractiveness. Also factors affecting human decisions such as mood of the interviewer, temporal placement of interview questions etc. can be greatly reduced by use of the system described in claim 1

7. I claim that the deployment and adoption of the automated system described in claim 1 above will result in great reduction in Direct Costs of the Selection Process for the adopting Organisation/Client by way of freeing up staff from cumbersome often completely non-automated screening and selection processes.

8. I claim that the implementation of this system, described in claim 1, will result in great reduction in Indirect Costs of the Selection Process for the adopting organisation by way of Reduction in Cost of Consequence due to hiring mistakes made by less trained and skilled ‘human’ hiring Managers or less trained technical staff assigned to such work. This innovation will further reduce the cost of unnecessarily employing semi-skilled HR personnel and will further enhance the significance of the ‘best-in-trade’ creative HR managers who cannot be readily replaced by Automation.

9. I claim that the use of this innovative system described in 1 should result in Reduction in Liability Risks for the Adopting Organisation due to:
a) Automation of a potentially flawed previous manual process which introduces human bias in interview selections.
b) Better record keeping to ensure that if and when liability occurs, records can be readily produced by the system in order to cater to queries by Government Justice Department personnel or prosecuting and defence attorneys as the case may be (EEOC data)
c) Built in Automated Compliance mechanisms which can be updated via tested software patches as required to comply with new Laws introduced by Governments Worldwide.

10. I claim that the deployment of our automated system described in claim 1, will result in the conduct of a more thorough candidate evaluation because of a theoretically unlimited time period for the testing of the candidate by the system (with breaks in between). Also, a longer offline evaluation time to run backend evaluation algorithms (machine learning, AI, NLP and Statistics) to come up with an automated candidate performance report.

11. The system described in claim 1 will result in providing the following outputs in the form of a report to the Hiring Manager, after analysing every Candidates' response in totality:
A. System's Hiring Decision (Y/N)
B. Scaled automated Technical skill evaluation score (0-100 Scaled
C. automated Technical interview score (0-100)
D. Scaled automated HR interview score (0-100)
E. Scaled Job Fitment Score between Candidate and the Job Description provided by the Hiring (Client) Organisation (0-100)
F. Probability of the candidate joining the organisation (0%-100%)
G. System compensation recommendation (based on budget range for the position)
H. Final face-to-face HR interview score (0-100)
I. List of Red flags detected in human interview (if any)
J. Offer rolled out to candidate (Y/N).

12. I claim that the Applicability of our innovation is designed for the following organisation types:
A. Commercial Corporate Establishments
B. Non Commercial, (not for-profit) Establishments.

13. Further to claim 12, I claim that the adoption of our System and Method by an Organisation described will result in improvement in intake quality due to relaxation of the following constraints:
A. Reduced need for excessive resume scanning and scrutiny for positions where a directly measurable skill is required to be evaluated by the system (e.g. Computer Programming in a certain Language)
B. Hiring Managers can now focus on evaluating the candidate's truly “human” factors, if at all, for the job for which hiring is under progress
C. Separate the creative human parts from the repetitive machine automate-able parts.

14. I claim that further to claim 12, the applicability of our System and Method is for candidate selection (hiring) and also for unbiased selection during promotions or job changes within the same Organisation.

15. I claim that the system described in claim 1 removes Manipulative behaviour such as “Impression Management” by way of Automating the Test and Evaluation of the interviews. Impression management is oftentimes used by candidates to fool interviewers in a short face to face interview.

16. I claim that the disadvantages which can be introduced inadvertently by human Interviewers/Hiring managers due to temporal placement of questions are eliminated by a standardised “Question Selection Sub-System” which is a part of the system described in claim 1

17. I claim that the system described in claim 1 above will serve as a Pluggable Cloud-based Skill Testing Platform for technical skills (pluggable question/answer sets by skill) and also for Human Resources tests.
